(19) United States
(12) Patent Application Publication
(10) Pub. No.: US 2020/0045196 A1
(43) Pub. Date: Feb. 6, 2020

(54) INFORMATION PROCESSING APPARATUS AND CONTROL METHOD OF INFORMATION PROCESSING APPARATUS

(71) Applicant: CANON KABUSHIKI KAISHA, Tokyo (JP)

(72) Inventor: Takeru Imamura, Nagareyama-shi (JP)

(21) Appl. No.: 16/458,780

(22) Filed: Jul. 1, 2019

(30) Foreign Application Priority Data
Aug. 1, 2018 (JP) 2018-144708

(51) Int. Cl. H04N 1/00; G03G 15/00

(52) U.S. Cl. CPC H04N 1/00896; G03G 15/5004; H04N 1/00082; H04N 1/00037

(57) ABSTRACT

In a case where a failure is detected in an information processing apparatus, power supplied to blocks other than a storage is turned off, and a load of a power supply unit for supplying power to each of the blocks is reduced. A period of time the power can be supplied to the storage is extended thereby, so that the time necessary for writing cache data into a main body of the storage can be secured.

### BACKGROUND

### Field

The present disclosure relates to an information processing apparatus including a storage, and particularly relates to an information processing apparatus provided with a unit for preventing cache data stored in the storage from being lost when a failure has occurred.

### Description of the Related Art

In many cases, in order to ensure security, an information processing apparatus has a function for automatically turning off power when a failure is detected. Herein, a system failure or a power supply failure is considered as a failure occurring in the information processing apparatus.

A failure caused by a phenomenon that the software for operating the information processing apparatus hangs or an operation failure of a device provided inside the information processing apparatus caused by thermal abnormality may be considered as the system failure. The information processing apparatus detects the above-described failure as a system failure.

When the above-described system failure is detected, it is preferable that the power of the information processing apparatus be shut down as quickly as possible in order to return the information processing apparatus to a safe state as soon as possible. Therefore, the information processing apparatus has a function of automatically turning off the power when a failure is detected, different from a case of a normal shutdown.

Further, for example, a failure caused by the lowering of an input voltage supplied from an external power supply unit can be considered as the power supply failure.

A non-volatile memory such as a hard disk drive (HDD) or a solid-state drive (SSD) is commonly used as a storage included in the information processing apparatus. Further, it is often the case that a storage mounted on the information processing apparatus includes a cache memory in order to maintain high performance.

Data stored in the cache memory will be lost if the power of the storage is turned off. Therefore, in order to retain data even though the power is off, the data has to be written into the storage main body from the cache memory before the power is off.

However, in a case where a failure has occurred, the power of the storage may be shut down suddenly, and thus there is a risk in which data stored in the cache memory is lost. Therefore, when the information processing apparatus is reactivated, there is a possibility that not only the data stored in the cache memory is lost but also an error occurs in the operation of the information processing apparatus itself because of loss of saved data.

Japanese Patent Application Laid-Open No. 2000-122813 discusses a disk array apparatus which detects the occurrence of a blackout when an amount of input power is lowered to a certain amount or less, and quickly stops writing of data and normally terminates the data writing process by outputting a reset signal to a storage.

Further, in order to ensure that cache data is written into the storage even in a case where a failure, such as lowering of input voltage, has occurred, a large amount of power will be necessary because the information processing apparatus needs to continuously operate as a system. Therefore, detecting the lowering of an input voltage at a high threshold voltage value or providing a high-capacity capacitor to the system may be considered.

However, if lowering of the input voltage is detected at a high threshold voltage value, lowering of the voltage within a range practically having no influence may be determined as a failure. Further, if a high-capacity capacitor is provided to the system, cost or power consumption of the hardware will be increased.

### SUMMARY

According to an aspect of some embodiments, an information processing apparatus includes a plurality of devices including a storage, a power supply control unit configured to execute power supply control for turning on and off power of the plurality of devices, and a failure detection unit configured to detect a failure occurring in the information processing apparatus, wherein, in a case where the failure detection unit detects a failure occurring in the information processing apparatus, the power supply control unit turns off power of the storage after turning off power of at least one of the devices other than the storage.

Further features of various embodiments will become apparent from the following description of exemplary embodiments with reference to the attached drawings.

### BRIEF DESCRIPTION OF THE DRAWINGS

FIG. 1 is a block diagram illustrating a hardware configuration of an image forming apparatus.

FIG. 2 is a block diagram of a portion relating to a power supply of the image forming apparatus.

FIG. 3 is a flowchart illustrating processing according to a first exemplary embodiment executed when a power supply control unit detects a failure.

FIGS. 4A and 4B are timing charts illustrating changes in each element, such as a power supply control signal, according to the first exemplary embodiment.

FIG. 5 is a flowchart illustrating processing according to a second exemplary embodiment executed when a power supply control unit detects a failure.

FIGS. 6A to 6D are timing charts illustrating changes in each element, such as a power supply control signal, according to the second exemplary embodiment.

FIG. 7 is a block diagram illustrating a hardware configuration of an image forming apparatus according to a third exemplary embodiment.

FIG. 8 is a flowchart illustrating processing according to the third exemplary embodiment executed when a power supply control unit detects a failure.

FIGS. 9A and 9B are timing charts illustrating changes in each element, such as a power supply control signal, according to the third exemplary embodiment.

FIG. 10 is a block diagram illustrating a hardware configuration (main portion) of an image forming apparatus according to a fourth exemplary embodiment.

FIG. 11 is a flowchart illustrating processing according to the fourth exemplary embodiment executed when a power supply control unit detects a failure.

FIG. 12A to 12C are timing charts illustrating changes in each element, such as a power supply control signal, according to the fourth exemplary embodiment.

### DESCRIPTION OF THE EMBODIMENTS

Hereinafter, an exemplary embodiment will be described with reference to the appended drawings.

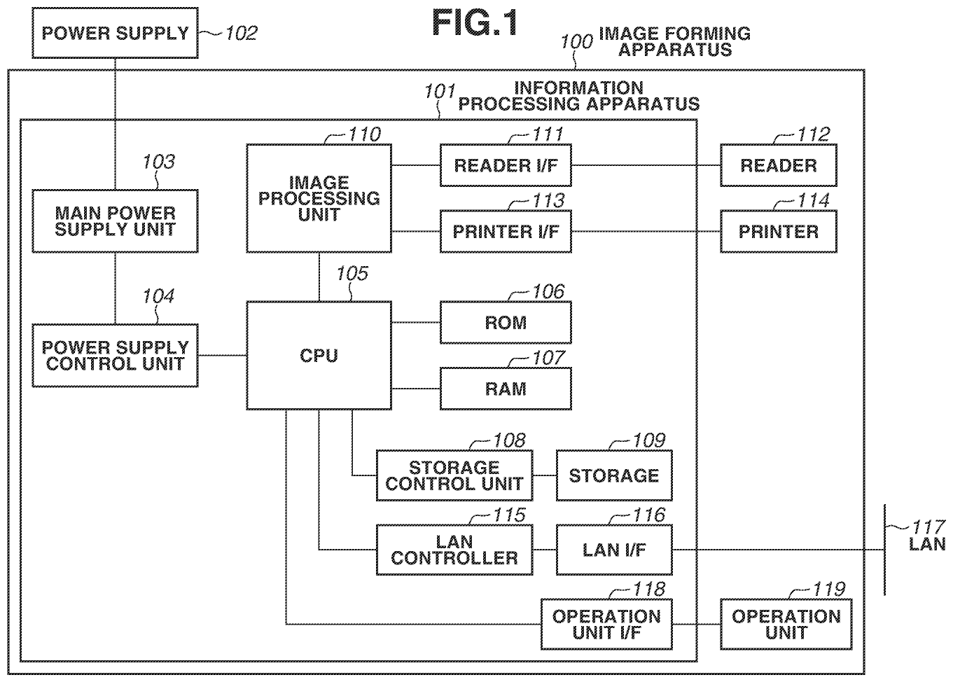

FIG. 1 is a block diagram illustrating a hardware configuration of an image forming apparatus.

A first exemplary embodiment will be described below. In the present exemplary embodiment, an image forming apparatus 100 configured as an information processing apparatus 101 having a printer and a reader will be described. However, in addition to the image forming apparatus, an apparatus such as a personal computer (PC) can be also configured by using a similar information processing apparatus 101.

In the image forming apparatus 100 in FIG. 1, the information processing apparatus 101 includes devices, such as a central processing unit (CPU) 105, a storage 109, and an image processing unit 110, which require power supplied from a main power supply unit 103.

The CPU 105 executes a software program to control the entirety of the information processing apparatus 101.

A random access memory (RAM) 107 is used for temporarily storing data when the CPU 105 controls the image forming apparatus 100. A read only memory (ROM) 106 stores an activation program and various setting values of the image forming apparatus 100.

The information processing apparatus 101 is connected to a local area network (LAN) 117 via a LAN controller 115 and a LAN interface (I/F) 116.

A storage 109 is connected to the CPU 105 via a storage control unit 108. The storage 109 is configured of a non-volatile storage medium, such as a hard disk drive (HDD) or a solid state drive (SSD). Further, separate from a storage main body, the storage 109 further includes a cache memory for temporarily saving data.

The CPU 105 and the storage control unit 108 are connected to each other using a serial advanced technology attachment (hereinafter, referred to as “SATA”). The storage 109 may be directly connected to the CPU 105 if the storage control unit 108 is not arranged thereon.

According to an instruction from the CPU 105, the storage control unit 108 communicates with the storage 109 to read or write data.

Further, a parallel advanced technology attachment (hereinafter, referred to as “PATA”) I/F may be used in place of the SATA. Although a detailed description will be omitted, processing similar to the processing executed using the SATA will be executed by using a PATA command.

An operation unit 119 includes a liquid crystal panel and hard keys for executing operation, and accepts an instruction input by a user. The operation unit I/F 118 serves as an interface that connects the information processing apparatus 101 and the operation unit 119.

The CPU 105 is connected to a reader 112 via a reader I/F 111. The reader 112 includes an auto-document feeder (ADF) and a scanner unit, and reads an image of a document placed on the ADF or a document positioning plate. The image processing unit 110 generates image data from the read image.

Further, the CPU 105 is connected to a printer 114 via a printer I/F 113. Based on the image data generated by the image processing unit 110, the printer 114 prints an image on a sheet.

A power supply control unit 104 detects a failure, such as a system failure or a power supply failure, occurring in the information processing apparatus 101.

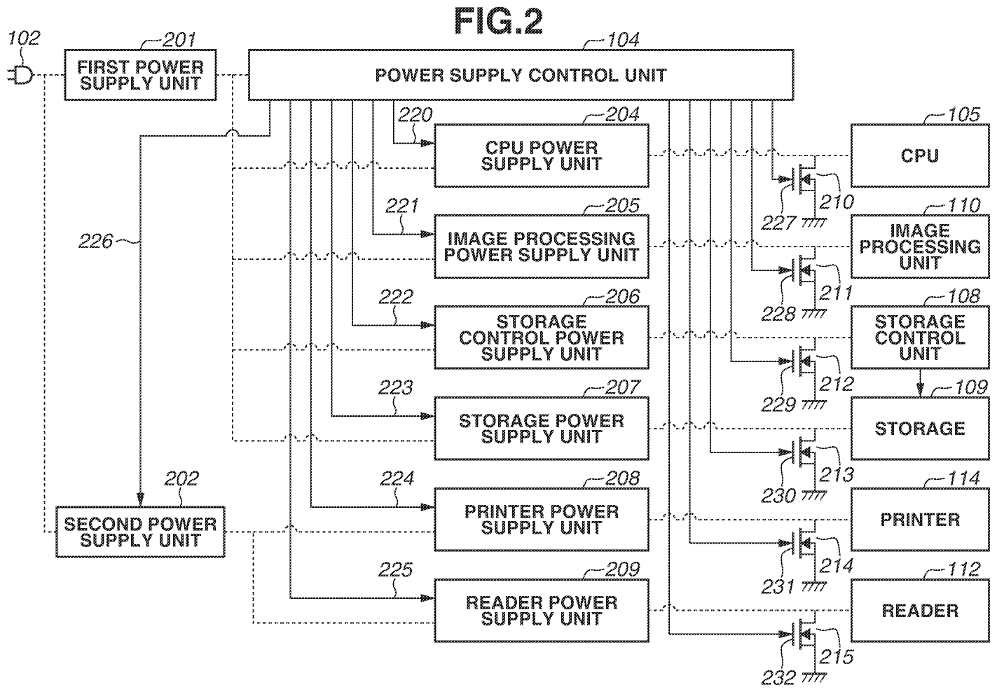

Further, the power supply control unit 104 executes power control of the image forming apparatus 100. In other words, as described below in FIG. 2, the power supply control unit 104 controls the power generated by the main power supply unit 103 connected to the power supply 102 to be supplied or stopped with respect to the respective devices.

As described above, in the present exemplary embodiment, the power supply control unit 104 has both of the function for detecting a failure and the function for executing control of supplying or stopping power. However, the respective functions may be executed by different devices.

The image forming apparatus 100 includes a power saving mode, as a power mode, in addition to a normal mode. The power supply control unit 104 may execute control of changing the power mode of the image forming apparatus 100. However, in the block diagram of the hardware configuration of the image forming apparatus 100 illustrated in FIG. 1, a configuration with respect to the power mode of the image forming apparatus 100 is not illustrated.

FIG. 2 is a block diagram illustrating a supply of power in the image forming apparatus 100.

The power received from the power supply 102 is supplied to a first power supply unit 201 and a second power supply unit 202.

The first power supply unit 201 corresponds to the main power supply unit 103 illustrated in FIG. 1 and supplies power to the power supply control unit 104. The power supply control unit 104 controls the respective ON/OFF states of power supply units 202 and 204 to 209 in FIG. 2.

In FIG. 2, a dotted line represents a power line for supplying power, and a solid line represents a signal line for transmitting and receiving a control signal.

The power supply control unit 104 outputs power supply control signals 220 to 226 to power supply units 202 and 204 to 209 in order to enable devices 105, 108 to 110, 112, and 114 to be turned ON and OFF individually.

Herein, each of the devices and a corresponding power supply unit for supplying power to the device are collectively called a “block”.

Specifically, the CPU 105 and the CPU power supply unit 204 constitute one block, and the image processing unit 110 and the image processing power supply unit 205 also constitute one block. Similarly, the storage control unit 108 and the storage control power supply unit 206, the storage 109 and the storage power supply unit 207, the printer 114 and the printer power supply unit 208, and the reader 112 and the reader power supply unit 209 constitute respective blocks.

When the respective blocks are to be turned off, the power supply control unit 104 not only turns off the power supply to the power supply units 204 to 209 but also activates charge elimination circuits 210 to 215 to regulate the respective blocks.

Herein, “charge elimination” refers to processing for eliminating electric charges accumulated in the device through a ground, and the charge elimination circuit is a circuit that is provided for that purpose.

Further, in FIG. 2, for the sake of simplicity, only transistors 227 to 232 are illustrated as the charge elimination circuits 210 to 215. However, in practice, in order to regulate each of the blocks, a resistor is used for adjusting a value of electric current flowing therein.

Further, in order to suppress the power consumption, with respect to a block including a device having a large power load, such as the printer 114 or the reader 112, a second power supply unit 202 is arranged separately from the first power supply unit 201. Then, the power supply control unit 104 supplies power to the printer 114 or the reader 112 via the second power supply unit 202 only when necessary.

Hereinafter, exemplary embodiments will be described briefly.

In a first exemplary embodiment, when a failure is detected, power supplied to the blocks other than the storage 109 is turned off, so that a load of the power supply unit for supplying power to each of the blocks is reduced. With this configuration, a period of time the power can be supplied to the storage 109 is extended, so that the time for writing cache data into the main body of the storage 109 can be secured.

Further, in a second exemplary embodiment, a power supply control signal transmitted to the storage power supply unit 207 is changed depending on a structure of a power supply switch (SW), so that the time for writing cache data into the main body of the storage 109 can be secured even in a case where a state of the power supply SW cannot be confirmed.

Further, in a third exemplary embodiment, a load of the power supply unit is reduced quickly by executing reset control of the storage control unit 108.

Furthermore, in a fourth exemplary embodiment, a load of the power supply unit is reduced more quickly by combining the reset control of the storage power supply unit 207 and the storage control unit 108.

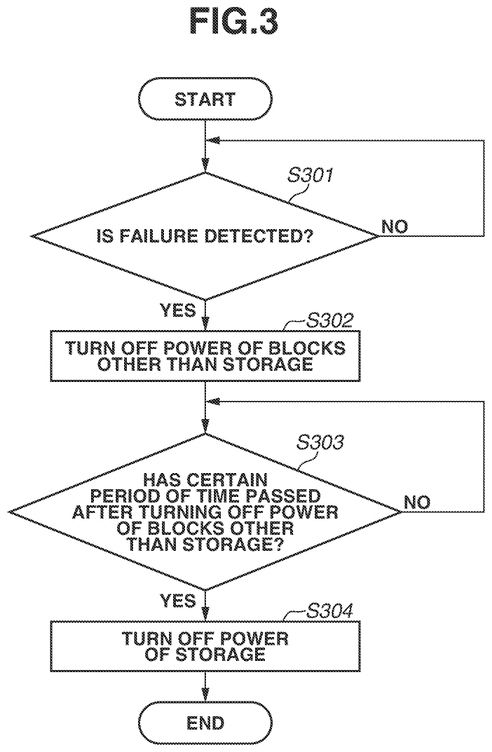

In the first exemplary embodiment, when a failure is detected, the power supply control unit 104 turns off the power supplied to the blocks other than the storage 109. With this configuration, a load of the main power supply unit 103 for supplying power to each of the blocks is reduced, and a period of time the power can be supplied to the storage 109 is extended, so that the time for writing cache data into the main body of the storage 109 can be secured. FIG. 3 is a flowchart illustrating control processing for securing the time for writing data (cache data) temporarily stored in a cache memory of the storage 109 into the main body of the storage 109 when the power supply control unit 104 detects a failure.

In S301, the power supply control unit 104 determines whether a failure is detected.

The power supply control unit 104 detects failures such as a system failure and a power supply failure.

For example, a failure caused by a software hang and an operation failure of a device caused by a thermal abnormality may be considered as system failures. Further, for example, a failure occurring in the input voltage supplied from the power supply unit may be considered as the power supply failure.

In addition, the image forming apparatus 100 executes normal operation until the power supply control unit 104 detects a failure in S301. When the normal operation is executed, the power supply control unit 104 executes power supply control of each of the blocks according to an instruction from the CPU 105. For example, power supply control executed in the normal operation may be control for shifting a power mode to a power saving mode and returning from the power saving mode or shutdown control.

Further, in a state where the power of the image forming apparatus 100 is off, the CPU 105 waits for a user instruction for turning on the power. On the other hand, in a state where the image forming apparatus 100 is activated, the CPU 105 receives a user instruction for turning off the power and transmits an instruction for shifting a power state to a shutdown state to each of the blocks.

In S301, when the power supply control unit 104 detects a failure (YES in S301), the processing proceeds to S302.

In S302, the power supply control unit 104 turns off the power of the blocks other than the storage 109. Specifically, the power supply control unit 104 transmits the power supply control signals 220 to 222 and 224 to 226 to the power supply units 202, 204 to 206, 208, and 209 illustrated in FIG. 2, respectively, to turn off the respective outputs of the power supply units 202, 204 to 206, 208, and 209. Further, the power supply control unit 104 outputs an on-voltage to each of the gates of the transistors 227 to 229, 231, and 232 to enable the charge elimination circuits 210 to 212, 214, and 215.

Then, in S303, the power supply control unit 104 determines whether a certain period of time (t1) has passed after turning off the power of each of the blocks other than the storage 109. As it is often the case that a device, such as the HDD or the SSD, has a function for internally shifting cache data within a certain period of time after communication is disconnected, the power supply control unit 104 waits until the certain period of time (t1) has passed in order to secure the time for that function.

In S303, if the power supply control unit 104 determines that the certain period of time (t1) has passed (YES in S303), the processing proceeds to S304.

Then, in S304, the power supply control unit 104 turns off the power of the storage 109. At this time, as in the case of processing executed on the other power supply units 202, 204 to 206, and 208 to 209, the power supply control unit 104 transmits a power supply control signal 223 to the storage power supply unit 207 to turn off the output. Further, the power supply control unit 104 outputs an on-voltage to a gate of the transistor 230 and enables the charge elimination circuit 213.

As described above, in the present exemplary embodiment, when a failure is detected, the power supply control unit 104 turns off the power of each of the blocks other than the storage 109 and disconnects communication between the blocks in order to reduce a load of the main power supply unit 103. With this configuration, a load of supplying power to each block is reduced, and a period of time the power can be supplied to the storage 109 is extended, so that the time for writing cache data into the main body of the storage 109 can be secured.

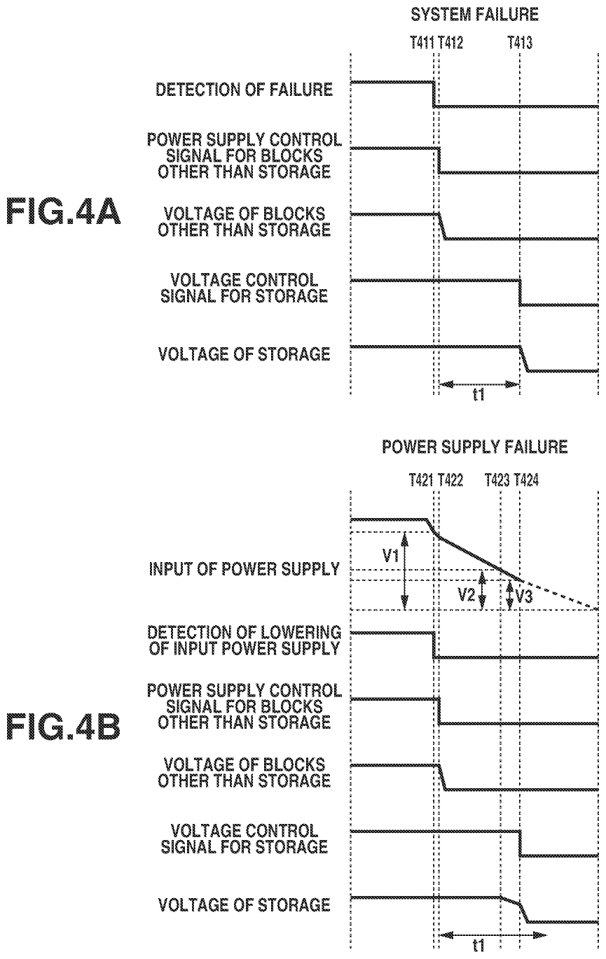

FIGS. 4A and 4B are timing charts specifically illustrating power supply control according to the present exemplary embodiment.

FIG. 4A is an example of a timing chart of an element such as the power supply control signal when the system failure has occurred. Further, FIG. 4B is an example of a timing chart of an element such as the power supply control signal when the power supply failure has occurred.

In FIG. 4A, a timing T411 is a timing when the power supply control unit 104 detects a system failure.

For example, when a software hang has occurred, the power supply control unit 104 detects a system failure by recognizing a failure relating to delay of an input signal via a watchdog timer (WDT) arranged thereon. Further, the CPU 105 detects a temperature abnormality or an operation failure of the device and transmits an instruction to the power supply control unit 104, so that the power supply control unit 104 detects the failure.

When a system failure is detected, the power supply control unit 104 transmits a turn-off instruction to each of the blocks other than the storage 109 at a timing T412.

Specifically, the turn-off instruction transmitted to each of the blocks other than the storage 109 is an instruction for turning off the power supply units 202, 204 to 206, 208, and 209 and enabling the respective charge elimination circuits 210 to 212, 214, and 215.

When each of the power supply units 202, 204 to 206, 208 and 209 receives the turn-off instruction from the power supply control unit 104, each of the blocks is turned off. The power supply control unit 104 outputs the turn-off instruction and measures the passage of the certain period of time (t1).

When the certain period of time (t1) has passed, the power supply control unit 104 outputs an instruction for turning off the power of the storage 109. Specifically, at a timing T413, the power supply control unit 104 outputs a turn-off instruction to the storage power supply unit 207, enables the charge elimination circuit 213, and stops feeding power to the storage 109.

In FIG. 4B, a timing T421 is a timing when the power supply failure has occurred.

The power supply control unit 104 monitors the voltage input from the power supply 102 to the information processing apparatus 101 and detects a power supply failure when the input voltage is lowered (e.g., in FIG. 4B, the input voltage is a threshold value V1 or less) at an unexpected timing. Herein, the lowering of voltage occurs at an unexpected timing if a blackout has occurred or a plug is pulled out in a power-on state.

When a power supply failure is detected, the power supply control unit 104 transmits an instruction for turning off each of the blocks other than the storage 109 at a timing T422.

When each of the power supply units 202, 204 to 206, 208 and 209 receives the turn-off instruction from the power supply control unit 104, the blocks are each turned off.

Herein, because the power supply control unit 104 turns off the blocks other than the storage 109, a load of supplying power to each of the blocks is reduced. Therefore, lowering of the voltage of the power input to the storage power supply unit 207 from the power supply control unit 104 will be moderate.

The power supply control unit 104 outputs the turn-off instruction and measures the passage of the certain period of time (t1).

At this time, depending on a capacity of a capacitor connected to the storage 109 or the power supply control unit 104, the voltage of the input power is lowered at different speed. As a result, there is a possibility that the power supplied to the storage power supply unit 207 is lowered to cause the storage 109 to be turned off before the set certain period of time (t1) has passed.

In a case where the voltage of the input power can be retained for a certain period of time (t1) or longer, a timing chart will be similar to the timing chart illustrated in FIG. 4A. Therefore, in FIG. 4B, the exemplary embodiment will be described with respect to the case where the voltage of the input power cannot be retained for the certain period of time (t1).

For example, if the voltage of the input power becomes a certain voltage or lower (e.g., in FIG. 4B, a threshold value V2 or less) at a timing T423, a supply voltage for the storage 109 is lowered gradually in accordance with the lowering of the voltage of the input power.

Thereafter, when the voltage of the input power is further lowered (e.g., in FIG. 4B, a threshold value V3 or less) at a timing T424, the power supply control unit 104 stops the operation. Then, the power supply control unit 104 cannot supply power to the storage power supply unit 207, so that the storage 109 is turned off.

As illustrated in the timing charts in FIGS. 4A and 4B, in the present exemplary embodiment, the power of each of the blocks other than the storage 109 is turned off when a failure is detected. With this configuration, a load of supplying power to the blocks is reduced, and a period of time the power can be supplied to the storage 109 is extended. Therefore, the time for writing cache data into the main body of the storage 109 can be secured, and loss of data can be prevented or reduced.

The second exemplary embodiment will be described. In the second exemplary embodiment, the power supply control unit 104 changes the power supply control signal 223 transmitted to the storage power supply unit 207 depending on the structure of the power supply SW to secure the time for writing cache data into the main body of the storage 109.

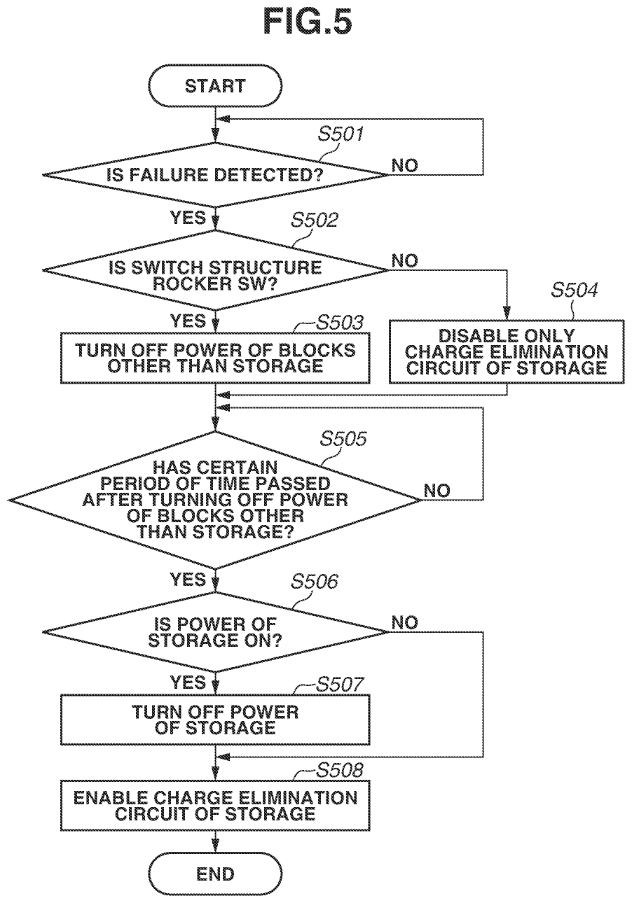

Similar to the flowchart in FIG. 3 described in the first exemplary embodiment, FIG. 5 is a flowchart illustrating control processing for securing the time for writing cache data into the main body of the storage 109 when the power supply control unit 104 detects a failure. Herein, processing different from processing illustrated in the flowchart in FIG. 3 will be mainly described.

In S501, the power supply control unit 104 determines whether a failure is detected.

In addition, the image forming apparatus 100 executes normal operation until the power supply control unit 104 detects a failure in S501. When the power supply control unit 104 detects a failure (YES in S501), the processing proceeds to S502.

In S502, the power supply control unit 104 changes the subsequent processing depending on whether a switch structure of the main power supply unit 103 is a rocker SW or a push SW.

If the switch structure is the rocker SW (YES in S502), the processing proceeds to S503. On the other hand, if the switch structure is the push SW (NO in S502), the processing proceeds to S504.

If the structure of the power supply SW is the rocker SW, in S503, the power supply control unit 104 turns off the power of each of the blocks other than the storage 109.

Specifically, the power supply control unit 104 turns off the outputs with respect to the power supply units 202, 204 to 206, 208, and 209, and enables the charge elimination circuits 210 to 212, 214, and 215.

Thereafter, in S505, the power supply control unit 104 determines whether the certain period of time (t1) has passed after turning off the power of the blocks other than the storage 109.

On the other hand, if a structure of the power supply SW is a push SW (NO in S502), the processing proceeds to S504. In S504, the power supply control unit 104 turns off the outputs with respect to the power supply units 202 and 204 to 209, including the storage power supply unit 207. Herein, although the power supply control unit 104 enables the charge elimination circuits 210 to 212, 214, and 215, the power supply control unit 104 maintains a disabled state of the charge elimination circuit 213 of the storage 109.

In the above, a control method for the power supply unit is changed depending on the structure of the power supply SW. This is because the power supply control unit 104 may or may not be able to confirm the state of the power supply SW depending on the structure of the power supply SW when the image forming apparatus 100 is to be returned from a failure.

In a case where the switch structure of the main power supply unit 103 is the rocker SW, the main power supply unit 103 can maintain the off state of the power supply SW when the main power supply unit 103 is turned off because of detection of a failure. Therefore, the power supply control unit 104 can restore the power of the main power supply unit 103 without an error by checking the state of the power supply SW.

On the other hand, if the switch structure of the main power supply unit 103 is the push SW, the main power supply unit 103 cannot maintain the off state of the power supply SW. Therefore, the power supply control unit 104 cannot check the state of the power supply SW, so that power cannot be restored appropriately.

Accordingly, if the switch structure of the main power supply unit 103 is a push SW, a state of the cache memory needs to be maintained as long as possible when a failure has occurred, so that a load of each of the blocks, including the storage 109, needs to be reduced as much as possible. Therefore, the power supply control unit 104 determines a structure of the power supply SW to change a power supply control method for the storage 109.

After the power supply control unit 104 outputs an instruction for turning off the power of each of the blocks, including the storage 109, in S504, the processing proceeds to S505.

Then, in S505, the power supply control unit 104 determines whether the certain period of time (t1) has passed after turning off each of the power supply units.

In S505, if the power supply control unit 104 determines that the certain period of time (t1) has passed (YES in S505), the processing proceeds to S506.

In S506, the power supply control unit 104 determines whether power of the storage 109 is ON. In other words, the power supply control unit 104 checks whether a switch structure of the main power supply unit 103 is the rocker SW or the push SW.

If the power of the storage 109 is ON (YES in S506), the processing proceeds to S507.

Then, in S507, the power supply control unit 104 turns off the power of the storage 109, and the processing proceeds to S508.

If the power of the storage 109 is OFF (NO in S506), the processing proceeds directly to S508.

In S508, the power supply control unit 104 enables the charge elimination circuit 213 of the storage 109.

As described above, in the present exemplary embodiment, when a failure is detected, the power supply control unit 104 changes a control method of the power supplied to the storage 109 depending on whether the SW structure of the main power supply unit 103 is a rocker SW or a push SW. With this configuration, even in a case where a state of the power supply SW cannot be checked because the SW structure of the main power supply unit 103 is a push SW, as much time for writing cache data can be secured as possible, so that loss of data can be prevented or reduced.

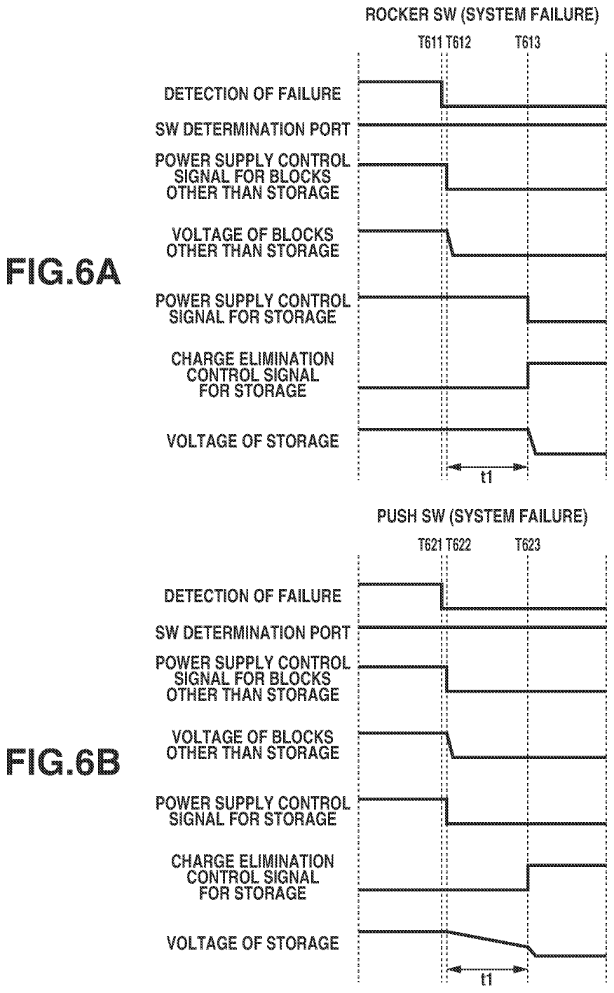

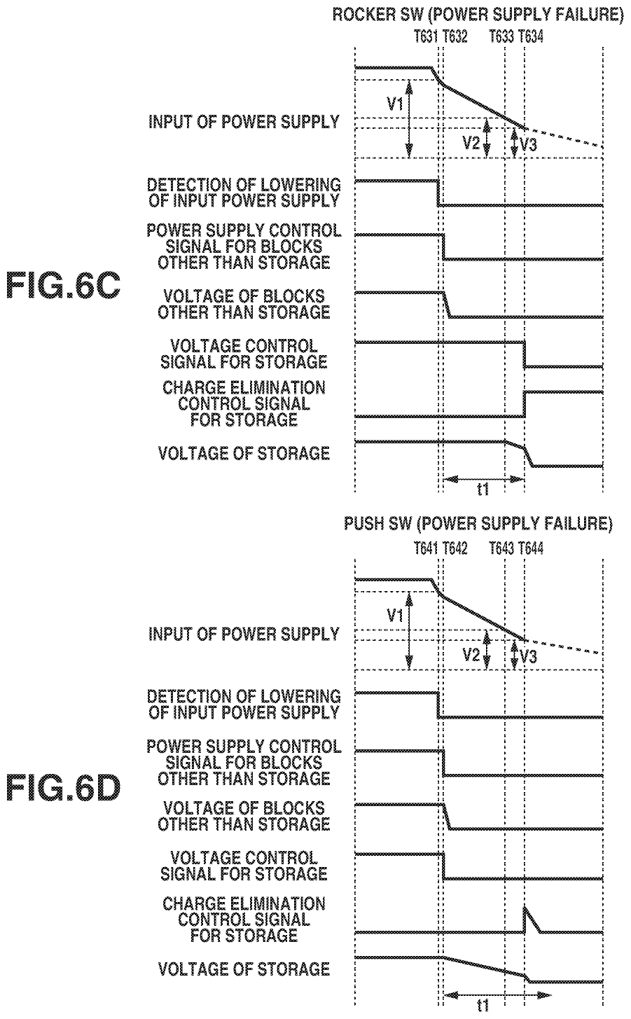

FIGS. 6A to 6D are timing charts specifically illustrating power supply control according to the present exemplary embodiment.

FIG. 6A is an example of a timing chart of an element, such as the power supply control signal, at the system failure when the SW structure of the main power supply unit 103 is a rocker SW. FIG. 6B is an example of a timing chart of an element, such as the power supply control signal, at the system failure when the SW structure of the main power supply unit 103 is a push SW.

FIG. 6C is an example of a timing chart of an element, such as the power supply control signal, at the power supply failure when the SW structure of the main power supply unit 103 is a rocker SW. FIG. 6D is an example of a timing chart of an element, such as the power supply control signal, at the power supply failure when the SW structure of the main power supply unit 103 is a push SW.

Herein, portions different from those illustrated in the timing charts in FIGS. 4A and 4B will be mainly described.

In FIG. 6A, a timing T611 is a timing when the power supply control unit 104 detects a system failure.

When the power supply control unit 104 detects a failure, the power supply control unit 104 transmits a turn-off instruction to each of the blocks other than the storage 109 at a timing T612.

When each of the power supply units 202, 204 to 206, 208, and 209 receives the turn-off instruction from the power supply control unit 104, the blocks are each turned off.

The power supply control unit 104 outputs the turn-off instruction and measures the passage of a certain period of time (t1).

When the certain period of time (t1) has passed, the power supply control unit 104 outputs the turn-off instruction to the storage power supply unit 207, enables the charge elimination circuit 213, and stops feeding power to the storage 109 at a timing T613.

Herein, because the power supply SW is a rocker SW, the power supply SW maintains the logic and constantly remains in the ON state even if the power supply control unit 104 detects a failure.

In FIG. 6B, a timing T621 is a timing when the power supply control unit 104 detects a system failure.

When a failure is detected, the power supply control unit 104 turns off the outputs with respect to the power supply units 202 and 204 to 209, including the storage power supply unit 207. However, with respect to the charge elimination circuit 213 of the storage 109, the power supply control unit 104 maintains a disabled state at a timing T622.

When each of the power supply units 202, 204 to 206, 208, and 209 receives the turn-off instruction from the power supply control unit 104, the blocks are each turned off.

The power supply control unit 104 outputs the turn-off instruction and measures the passage of a certain period of time (t1).

When the certain period of time (t1) has passed, the power supply control unit 104 enables the charge elimination circuit 213 of the storage 109 at a timing T623.

Herein, because the power supply SW is a push SW, the logic is not clear when a failure is detected, and thus the power supply SW is fixed to “Low” or “High” unless an instruction is provided by the user. In the power supply control sequence in FIG. 6B, it is assumed that the power supply SW is fixed to “Low”.

In FIG. 6C, a timing T631 is a timing when the power supply control unit 104 detects a power supply failure.

The power supply control unit 104 monitors the voltage input from the power supply 102 to the information processing apparatus 101 and detects a power supply failure when the input voltage is lowered (e.g., in FIG. 6C, the input voltage is a threshold value V1 or less) at an unexpected timing.

When a failure is detected, the power supply control unit 104 transmits an instruction for turning off each of the blocks other than the storage 109 at a timing T632.

When each of the power supply units 202, 204 to 206, 208, and 209 receives the turn-off instruction from the power supply control unit 104, the respective blocks are each turned off.

Herein, because the power supply control unit 104 turns off each of the blocks other than the storage 109, a load of supplying power to each of the blocks is reduced, so that the lowering of the voltage of the input power will be moderate.

The power supply control unit 104 outputs the turn-off instruction and measures the passage of a certain period of time (t1).

At this time, similar to the case described in FIG. 4B, there is a possibility that the power supplied to the storage power supply unit 207 is lowered to cause the storage 109 to be turned off before the set certain period of time (t1) has passed.

For example, if the voltage of the input power becomes a certain voltage or lower (e.g., in FIG. 6C, a threshold value V2 or less) at a timing T633, the supply voltage for the storage 109 is lowered gradually in accordance with the lowering of the voltage of the input power.

Thereafter, when the voltage of the input power is lowered further (e.g., in FIG. 6C, a threshold value V3 or less), the power supply control unit 104 stops the operation. Thus, an output for turning on the power of the storage 109 cannot be secured, so that the storage 109 is turned off at a timing T634.

In FIG. 6D, a timing T641 is a timing when the power supply control unit 104 detects a power supply failure.

The power supply control unit 104 monitors the voltage input to the information processing apparatus 101 and detects the power supply failure when the input voltage is lowered (e.g., in FIG. 6D, the input voltage is a threshold value V1 or less) at an unexpected timing.

When a failure is detected, the power supply control unit 104 turns off the outputs with respect to the power supply units 202 and 204 to 209, including the storage power supply unit 207. However, with respect to the charge elimination circuit 213 of the storage 109, the power supply control unit 104 maintains a disabled state at a timing T642.

When each of the power supply units 202, 204 to 206, 208, and 209 receives the turn-off instruction from the power supply control unit 104, the respective blocks are each turned off.

Herein, because the power supply control unit 104 turns off the power of each of the blocks other than the storage 109, a load of supplying power to each of the blocks is reduced, so that the lowering of the voltage of the input power will be moderate.

After outputting the turn-off instruction, the power supply control unit 104 measures the passage of a certain period of time (t1).

At this time, similar to the case described in FIG. 6C, if the input voltage becomes a certain voltage or lower, (e.g., in FIG. 6D, a threshold value V2 or less) at a timing T643, the supply voltage for the storage 109 is lowered gradually in accordance with the lowering of the input voltage.

Thereafter, when the input voltage is lowered further (e.g., in FIG. 6D, a threshold value V3 or less), the power supply control unit 104 stops the operation. Therefore, the power supply control unit 104 cannot supply power to the storage 109, so that the storage 109 is turned off at a timing T644.

As illustrated in the timing charts in FIGS. 6A to 6D, in the present exemplary embodiment, power supply control of the storage 109 is changed depending on the SW structure of the power supply SW, so that a period of time the power is supplied to the storage 109 can be extended. With this configuration, even in a case where a state of the power supply SW cannot be confirmed, as much time for writing cache data can be secured as possible, so that it is possible to prevent or reduce loss of data.

The third exemplary embodiment will be described. In the third exemplary embodiment, communication between the storage 109 and the storage control unit 108 is disconnected by controlling a reset signal transmitted to the storage control unit 108. With this configuration, a load of the main power supply unit 103 is reduced, and the time for writing the cache data into the main body of the storage 109 can be secured.

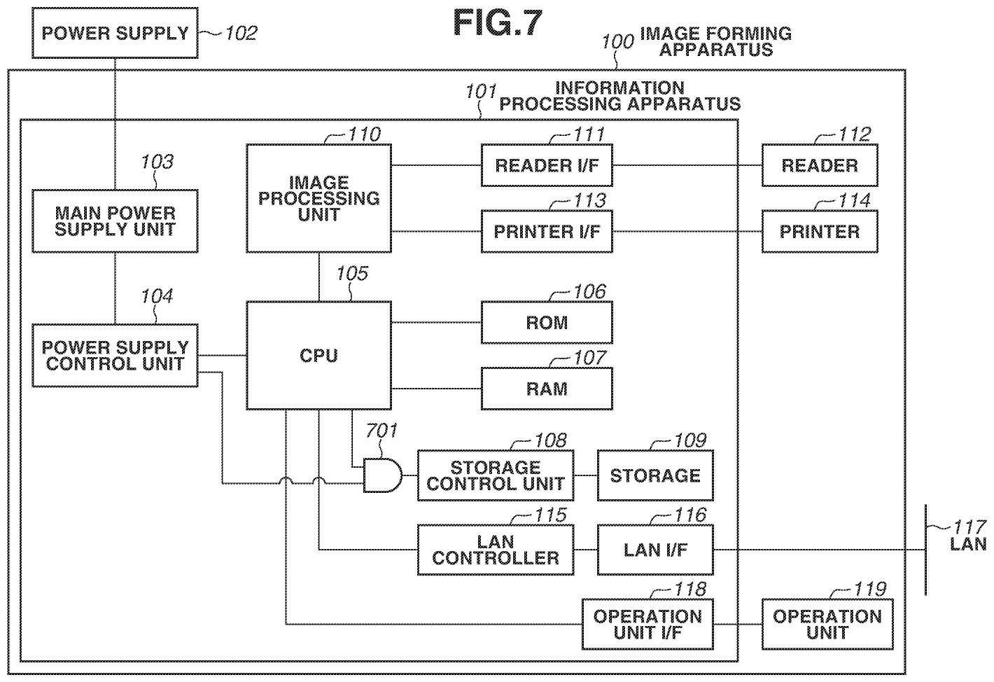

FIG. 7 is a block diagram illustrating a hardware configuration of an image forming apparatus according to the third exemplary embodiment.

A difference between the present exemplary embodiment and the first exemplary embodiment illustrated in FIG. 1 is that the hardware configuration includes an AND gate, so that both of the power supply control unit 104 and the CPU 105 can reset the storage control unit 108.

In the example illustrated in FIG. 7, an AND gate 701 is used based on the assumption that the output is changed to “Low” when the storage control unit 108 is reset by one or both of the power supply control unit 104 and the CPU 105. However, the logic or the structure of the circuit may be different as long as a reset can be executed by one or both of the power supply control unit 104 and the CPU 105. Herein, the exemplary embodiment will be described based on the configuration in FIG. 7.

Normally, since the storage control unit 108 operates according to an instruction of the CPU 105, the storage control unit 108 is brought into a reset state by a reset signal transmitted from the CPU 105. In the present exemplary embodiment, in order to quickly execute control when the power supply control unit 104 detects a failure, such as a blackout, the storage control unit 108 can be reset by a reset signal transmitted from the power supply control unit 104 for detecting a failure.

As described above, in the present exemplary embodiment, when a failure has occurred, the power supply control unit 104 can also reset the storage control unit 108. With this configuration, communication between the storage 109 and the storage control unit 108 is disconnected quickly, and the time for writing cache data into the main body of the storage 109 can be secured.

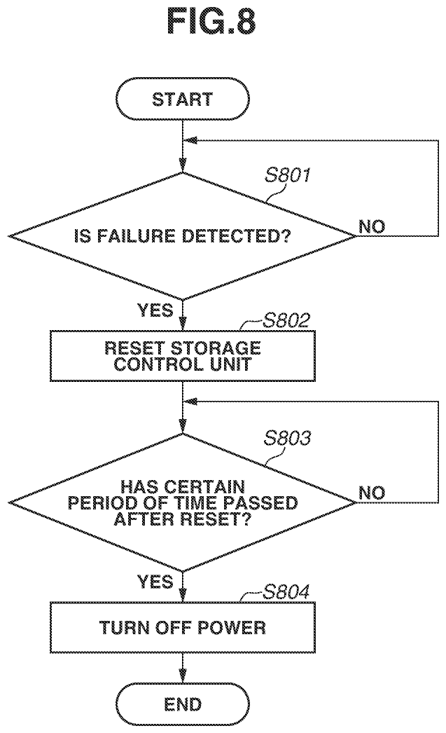

Similar to the flowchart in FIG. 3 described in the first exemplary embodiment, FIG. 8 is a flowchart illustrating control processing for securing the time for writing cache data into the main body of the storage 109 when the power supply control unit 104 detects a failure.

Herein, processing different from processing illustrated in the flowchart in FIG. 3 will be mainly described.

In S801, the power supply control unit 104 determines whether a failure is detected.

The image forming apparatus 100 executes normal operation until the power supply control unit 104 detects a failure in S801.

In S801, when the power supply control unit 104 detects a failure (YES in S801), the processing proceeds to S802.

Then, in S802, the power supply control unit 104 resets the storage control unit 108.

Thereafter, in S803, the power supply control unit 104 determines whether a certain period of time (t1) has passed after resetting the storage control unit 108.

In S803, if the power supply control unit 104 determines that the certain period of time (t1) has passed (YES in S803), the processing proceeds to S804.

Then, in S804, the power supply control unit 104 turns off each of the blocks.

As described above, in the present exemplary embodiment, when the power supply control unit 104 detects a failure, the power supply control unit 104 resets the storage control unit 108. With this configuration, communication between the storage 109 and the storage control unit 108 is disconnected quickly, and more time for writing cache data into the main body of the storage 109 can be secured.

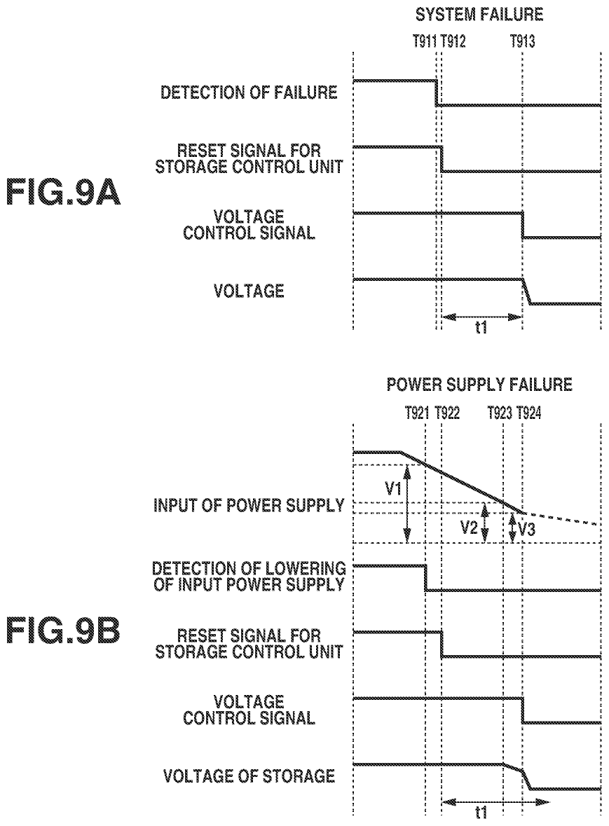

FIGS. 9A and 9B are timing charts specifically illustrating power supply control according to the present exemplary embodiment.

FIG. 9A is an example of a timing chart of an element, such as the power supply control signal, at the system failure. FIG. 9B is an example of a timing chart of an element such, as the power supply control signal, at the power supply failure.

Herein, portions different from those illustrated in the timing charts in FIGS. 4A and 4B will be mainly described.

In FIG. 9A, a timing T911 is a timing when the power supply control unit 104 detects a system failure.

When a system failure is detected, the power supply control unit 104 resets the storage control unit 108 at a timing T912.

When the power supply control unit 104 resets the storage control unit 108, communication between the storage control unit 108 and the storage 109 is disconnected.

The power supply control unit 104 resets the storage control unit 108 and measures the passage of a certain period of time (t1).

When the certain period of time (t1) has passed, the power supply control unit 104 transmits a turn-off instruction to each of the power supply units to turn off the respective blocks at a timing T913.

In FIG. 9B, a timing T921 is a timing when the power supply control unit 104 detects a power supply failure.

The power supply control unit 104 monitors the voltage input to the information processing apparatus 101 and detects a power supply failure when the input voltage is lowered (e.g., in FIG. 9B, the input voltage is a threshold value V1 or less) at an unexpected timing.

When a power supply failure is detected, the power supply control unit 104 resets the storage control unit 108 at a timing T922.

When the power supply control unit 104 resets the storage control unit 108, communication between the storage control unit 108 and the storage 109 is disconnected.

The power supply control unit 104 resets the storage control unit 108 and measures the passage of a certain period of time (t1).

At this time, similar to the case described in FIG. 4B, there is a possibility that power supplied to the storage power supply unit 207 is lowered to cause the storage 109 to be turned off before the set certain period of time (t1) has passed.

For example, if the input voltage becomes a certain voltage or lower at a timing T923 (e.g., in FIG. 9B, a threshold value V2 or less), the supply voltage for the storage 109 is lowered gradually in accordance with the lowering of the voltage of the input power.

Thereafter, when the input voltage is lowered further (e.g., in FIG. 9B, a threshold value V3 or less), the power supply control unit 104 stops the operation. Then, power supplied to the storage 109 cannot be secured, so that the storage 109 is turned off at a timing T924.

As illustrated in the timing charts in FIGS. 9A and 9B, in the present exemplary embodiment, when a failure is detected, the power supply control unit 104 resets the storage control unit 108. With this configuration, communication between the storage control unit 108 and the storage 109 is disconnected. As a result, the time necessary for writing cache data into the main body of the storage 109 is secured, and loss of data can be prevented or reduced.

The fourth exemplary embodiment will be described. In the fourth exemplary embodiment, by combining the reset control of the storage power supply unit 207 and the storage control unit 108, communication between the storage 109 and the storage control unit 108 can be disconnected more quickly. With this configuration, a load of the main power supply unit 103 can be more reduced, and more time for writing cache data into the main body of the storage 109 can be secured.

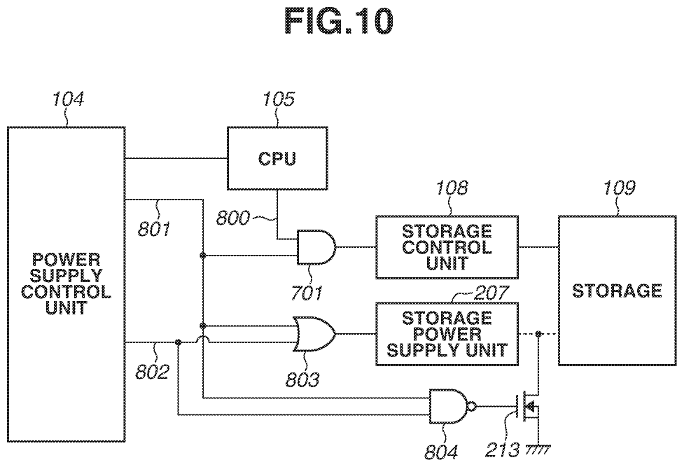

FIG. 10 is a block diagram illustrating a main portion of a hardware configuration of the image forming apparatus according to the present exemplary embodiment.

A difference between the present exemplary embodiment and the third exemplary embodiment in FIG. 7 is that reset control and power supply control of the storage 109 are executed by combining a reset signal 801 and a power supply control signal 802, respectively output to the storage control unit 108 and the storage power supply unit 207 from the power supply control unit 104.

When occurrence of a failure is detected, the power supply control unit 104 brings the storage control unit 108 into a reset state while continuously supplying power to the storage power supply unit 207. Therefore, an OR gate 803 is used for an input with respect to the storage power supply unit 207, and a NAND gate 804 is used for an input with respect to the charge elimination circuit 213 of the storage 109.

Herein, the present exemplary embodiment will be described based on the assumption that the storage power supply unit 207 is turned on when an input is “High”, and the storage control unit 108 is brought into a reset state when an input is “Low”. In a normal state, the power supply control unit 104 outputs “high” as both of the power supply control signal 802 and the reset signal 801. Therefore, the storage power supply unit 207 is ON, and the charge elimination circuit 213 is in a disabled state.

When a failure is detected, the power supply control unit 104 outputs “Low” as the reset signal 801. However, the storage power supply unit 207 needs to be maintained in an ON state, and the charge elimination circuit 213 needs to be maintained in the disabled state. Therefore, in order to maintain the ON state of the storage power supply unit 207 even if the power supply control signal 802 and the reset signal 801 are “High” and “Low” respectively, the OR gate 803 is arranged on the input side of the storage power supply unit 207. Further, in order to maintain the disabled state of the charge elimination circuit 213 even if the power supply control signal 802 and the reset signal 801 are “High” and “Low” respectively, the NAND gate 804 is arranged on the input side of the charge elimination circuit 213.

As described above, in the present exemplary embodiment, when a failure is detected, the power supply control unit 104 resets the storage control unit 108 while continuously supplying power to the storage 109. With this configuration, communication between the storage 109 and the storage control unit 108 can be disconnected more quickly, and more time for writing cache data into the main body of the storage 109 can be secured.

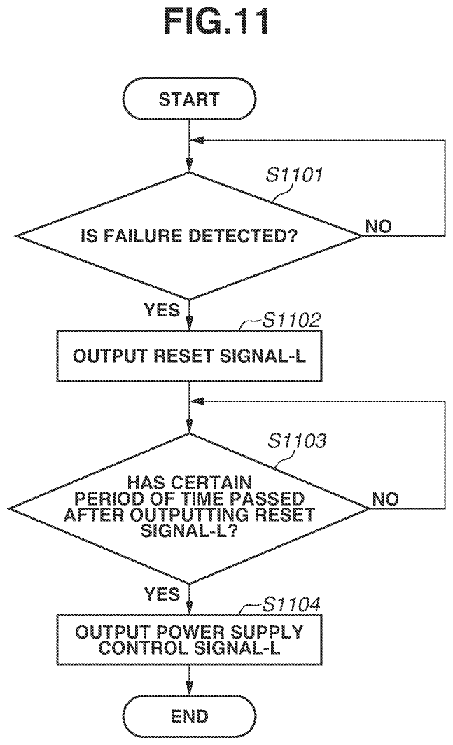

Similar to the flowchart in FIG. 3 described in the first exemplary embodiment, FIG. 11 is a flowchart illustrating control processing for securing the time necessary for writing cache data into the main body of the storage 109 when the power supply control unit 104 detects a failure.

Herein, processing different from processing illustrated in the flowchart in FIG. 3 will be mainly described.

In S1101, the power supply control unit 104 determines whether a failure is detected.

The image forming apparatus 100 executes normal operation until the power supply control unit 104 detects a failure in S1101.

When the power supply control unit 104 detects a failure (YES in S1101), the processing proceeds to S1102.

Then, in S1102, the power supply control unit 104 outputs “low” as a control signal to be output when a failure is detected. A reset signal 801 in FIG. 10 is the control signal to be output when a failure is detected.

When the power supply control unit 104 outputs “Low” as the reset signal 801, the storage control unit 108 is brought into a reset state, so that communication between the storage control unit 108 and the storage 109 is disconnected.

Thereafter, in S1103, the power supply control unit 104 determines whether a certain period of time (t1) has passed after outputting “Low” as the reset signal 801. As it is often the case that a device, such as the HDD or the SSD, has a function for internally shifting cache data within the certain period of time (t1) after communication is disconnected, the power supply control unit 104 waits until the certain period of time (t1) has passed in order to secure the time necessary for that function.

In S1103, if the power supply control unit 104 determines that the certain period of time (t1) has passed (YES in S1103), the processing proceeds to S1104.

Then, in S1104, the power supply control unit 104 changes the power supply control signal 802 to “Low” in order to turn off the power of the storage 109.

As described above, in the present exemplary embodiment, by combining the power supply control of the storage power supply unit 207 and the reset control of the storage control unit 108, communication between the storage 109 and the storage control unit 108 can be disconnected more quickly. With this configuration, a load of the main power supply unit 103 can be more reduced, and more time for writing cache data into the main body of the storage 109 can be secured.

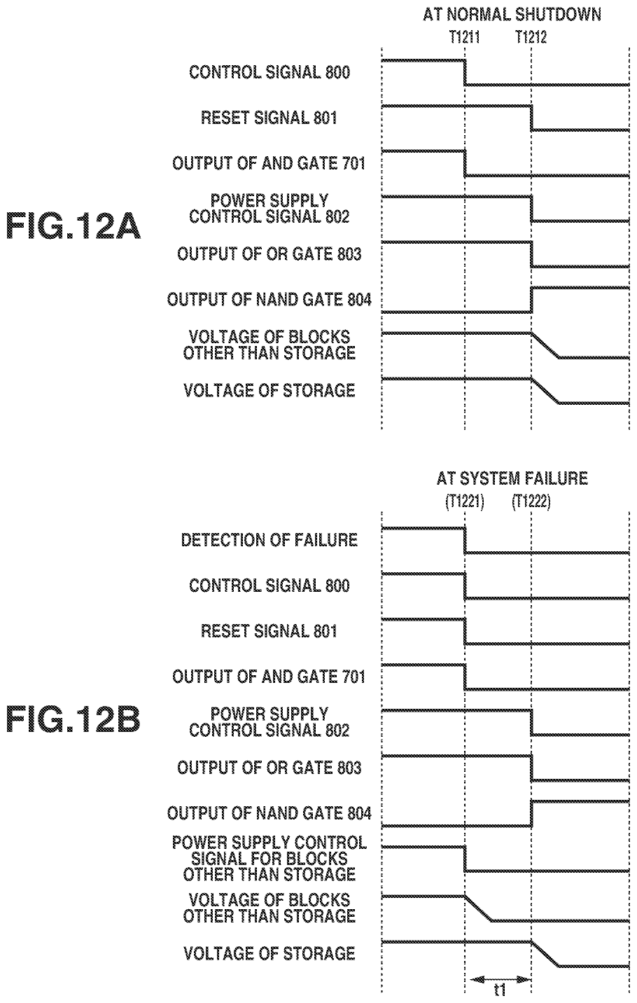

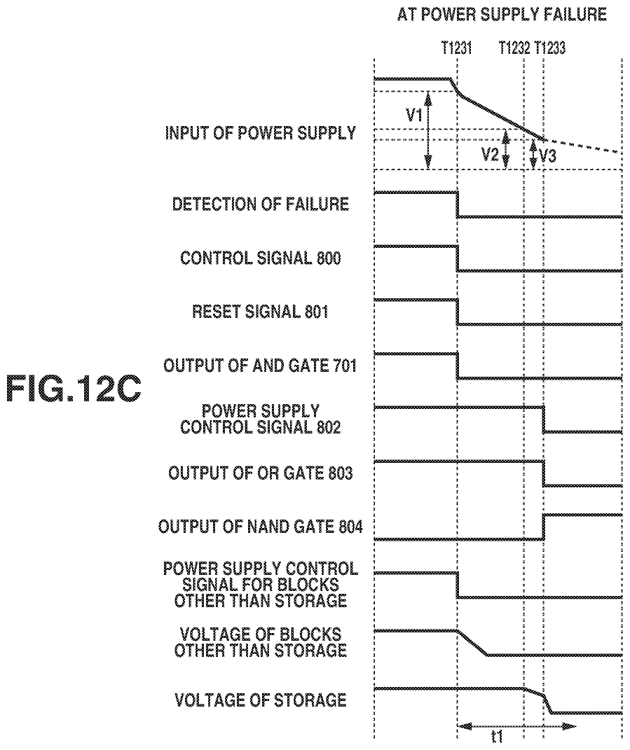

FIGS. 12A to 12C are timing charts specifically illustrating power supply control according to the present exemplary embodiment.

FIG. 12A is an example of a timing chart of an element, such as the power supply control signal, when normal shutdown is executed. FIG. 12B is a timing chart of an element, such as the power supply control signal, at the system failure. FIG. 12C is a timing chart of an element, such as the power supply control signal, at the power supply failure.

Herein, portions different from those illustrated in the timing chart in FIG. 4 will be mainly described.

In FIG. 12A, when an instruction for executing normal shutdown is received, the CPU 105 outputs a control signal 800 and resets the storage control unit 108 at a timing T1211 in order to execute shutdown.

The CPU 105 outputs “Low” as the control signal 800, so that an output of the AND gate 701 becomes “Low”. Then, the storage control unit 108 is brought into a reset state, and communication between the storage control unit 108 and the storage 109 is disconnected.

Thereafter, in order to execute shutdown processing, the CPU 105 instructs the power supply control unit 104 to turn of the power when preparation for turning off the power is completed.

The power supply control unit 104 receives the instruction for turning off the power from the CPU 105 and turns off each of the blocks. Herein, with reference to the timing charts in FIGS. 12A to 12C, a description is given focusing on the power supply control for the storage 109, so that only a reset signal 801 and the power supply control signal 802 are illustrated as the control signals in FIG. 10.

The power supply control unit 104 receives the instruction from the CPU 105 and changes the outputs of the reset signal 801 and the power supply control signal 802 at a timing T1212. The storage power supply unit 207 is then turned off, the charge elimination circuit 213 is enabled, and the storage 109 is turned off.

In FIG. 12B, a timing T1221 is a timing when the power supply control unit 104 detects a system failure.

When a system failure is detected, the power supply control unit 104 changes the reset signal 801 to “Low”.

When the reset signal 801 is changed to “Low”, the storage control unit 108 is brought into a reset state via the AND gate 701. At this time, the power supply control unit 104 also turns off the blocks other than the storage 109. Therefore, the CPU 105 is also changed to a reset state because the power thereof is turned off by the power supply control unit 104. Then, the control signal 800 for resetting the storage control unit 108 is also changed to “Low” accordingly.

On the other hand, in order to continue power feeding of the storage 109, the power supply control unit 104 maintains “High” as the power supply control signal 802 to maintain the storage power supply unit 207 in the ON state and the charge elimination circuit 213 in the disabled state.

The power supply control unit 104 changes the reset signal 801 to “Low” and measures the passage of the certain period of time (t1).

When the certain period of time (t1) has passed, the power supply control unit 104 outputs the turn-off instruction to the storage power supply unit 207 by changing the power supply control signal 802 to “Low” and turns off the power of the storage 109 at a timing T1222.

In FIG. 12C, a timing T1231 is a timing when the power supply control unit 104 detects a power supply failure.

The power supply control unit 104 monitors the voltage input to the image forming apparatus 100 and detects the power supply failure when the input voltage is lowered (e.g., in FIG. 12C, the input voltage is a threshold value V1 or less) at an unexpected timing.

When a failure is detected, the power supply control unit 104 changes the reset signal 801 to “Low”.

When the reset signal 801 is changed to “Low”, the storage control unit 108 is brought into a reset state via the AND gate 701. At this time, the power supply control unit 104 also turns off each of the blocks other than the storage 109. The CPU 105 is also changed to a reset state because power thereof is turned off by the power supply control unit 104. Then, the control signal 800 for resetting the storage control unit 108 is also changed to “Low” accordingly.

On the other hand, in order to continue power feeding of the storage 109, the power supply control unit 104 maintains “High” as the power supply control signal 802 to maintain the storage power supply unit 207 in the On state and the charge elimination circuit 213 in the disabled state.

At this time, similar to the case described in FIG. 4B, there is a possibility that power supplied to the storage power supply unit 207 is lowered to cause the storage 109 to be turned off before the set certain period of time (t1) has passed.

For example, if the voltage of the input power becomes a certain voltage or lower (e.g., in FIG. 12C, a threshold value V2 or less) at a timing T1232, the supply voltage for the storage 109 is lowered gradually in accordance with the lowering of the input voltage of the input power.

Thereafter, when the voltage of the input power is further lowered (e.g., in FIG. 12C, a threshold value V3 or less) at a timing T1233, the power supply control unit 104 stops the operation. Then, the power supply control unit 104 cannot supply power to the storage 109, so that the storage 109 is turned off.

As illustrated in the timing charts in FIGS. 12A to 12C, in the present exemplary embodiment, by combining power supply control of the storage power supply unit 207 and reset control of the storage control unit 108, communication between the storage 109 and the storage control unit 108 can be disconnected more quickly. With this configuration, a load of the main power supply unit 103 can be more reduced, and more time for writing cache data into the main body of the storage 109 can be secured, so that loss of data can be prevented or reduced.

### Other Embodiments

Some embodiment(s) can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2018-144708, which was filed on Aug. 1, 2018 and which is hereby incorporated by reference herein in its entirety.

What is claimed is:

1. An information processing apparatus comprising:
a plurality of devices including a storage;
a power supply control unit configured to execute power supply control for turning on and off power of the plurality of devices; and
a failure detection unit configured to detect a failure occurring in the information processing apparatus,
wherein, in a case where the failure detection unit detects a failure occurring in the information processing apparatus, the power supply control unit turns off power of the storage after turning off power of at least one of the devices other than the storage.

2. The information processing apparatus according to claim 1, wherein the power supply control unit turns off the power of the storage when a certain period of time has passed after the power of the at least one of the devices other than the storage is stopped.

3. The information processing apparatus according to claim 1, wherein charge elimination units for eliminating electric charges are arranged on the plurality of respective devices.

4. The information processing apparatus according to claim 3, wherein each of the charge elimination units includes a circuit including a transistor.

5. The information processing apparatus according to claim 3, wherein the power supply control unit turns off power of at least one of the devices by turning on at least one of the charge elimination units.

6. The information processing apparatus according to claim 1, further comprising a plurality of power supply units, each of which is arranged with respect to each of the respective devices, configured to supply power to the respective devices.

7. The information processing apparatus according to claim 6, wherein the power supply control unit turns off an output of at least one of the power supply units to turn off power of the corresponding device.

8. The information processing apparatus according to claim 3, wherein the power supply control unit turns off power of the storage by turning on the charge elimination unit for eliminating electric charges arranged on the storage.

9. The information processing apparatus according to claim 8, wherein, when power of the storage is turned off, the power supply control unit turns off an output of a power supply unit for supplying power to the storage arranged with respect to the storage.

10. The information processing apparatus according to claim 7, further comprising a main power supply for supplying power to the power supply control unit,
wherein, in a case where the failure detection unit detects a failure occurring in the information processing apparatus, the power supply control unit executes power supply control for turning on and off power of the storage depending on a switch structure of the main power supply.

11. The information processing apparatus according to claim 10, wherein, in a case where the switch structure of the main power supply is a rocker switch (SW), the power supply control unit turns off the power of the storage, and turns off the power of the at least one of the devices other than the storage before turning on a charge elimination unit for eliminating electric charges arranged on the storage.

12. The information processing apparatus according to claim 11, wherein, in a case where the switch structure of the main power supply is a push switch, the power supply control unit turns off the power of the storage and the power of the at least one of the devices other than the storage before turning on the charge elimination unit for eliminating electric charges arranged on the storage.

13. The information processing apparatus according to claim 1, wherein, in a case where the failure detection unit detects a failure occurring in the information processing apparatus, the power supply control unit resets a storage control unit for controlling the storage.

14. The information processing apparatus according to claim 13, wherein the power supply control unit resets the storage control unit by transmitting a reset signal.

15. The information processing apparatus according to claim 14, wherein, in a case where the failure detection unit detects a failure occurring in the information processing apparatus, the power supply control unit further transmits a reset signal to a power supply unit for supplying power to the storage which is arranged with respect to the storage.

16. The information processing apparatus according to claim 1, wherein the plurality of devices includes a central processing unit (CPU) as a device for controlling an entirety of the information processing apparatus.

17. The information processing apparatus according to claim 1, wherein the plurality of devices includes an image processing unit as a device for executing image processing.

18. The information processing apparatus according to claim 1, wherein the plurality of devices includes a storage control unit as a device for controlling the storage.

19. A control method for controlling an information processing apparatus having a plurality of devices including a storage, comprising:
turning off power of at least one of the devices other than the storage in a case where a failure detection unit detects a failure occurring in the information processing apparatus; and
turning off power of the storage after turning off the power of the at least one of the devices.
